(19) United States
(12) Patent Application Publication
(10) Pub. No.: US 2024/0089250 A1
(43) Pub. Date: Mar. 14, 2024

(54) SYSTEMS AND METHODS FOR TOKEN-BASED BROWSER EXTENSION FRAMEWORK

(71) Applicant: ROYAL BANK OF CANADA, Toronto (CA)

(72) Inventors: David CONWAY, Toronto (CA); Kouros ERSHADI, Toronto (CA)

(21) Appl. No.: 18/244,194

(22) Filed: Sep. 8, 2023

Related U.S. Application Data
(60) Provisional application No. 63/405,370, filed on Sep. 9, 2022.

(51) Int. Cl. H04L 9/40

(52) U.S. Cl. CPC H04L 63/083; H04L 63/20

(57) ABSTRACT

A computer-implemented system and method for orchestrating at least two extensions installed on a browser and for authenticating a user are disclosed. An example method for orchestration includes: receiving, by an extension orchestrator, from a browser launched on a user device, a request from a first extension manager associated with a first extension installed on the browser, the request comprising a first extension ID for the first extension and a second extension ID for a second extension installed on the browser; retrieving, based on the first and second extension IDs, a first extension configuration for the first extension and a second extension configuration for the second extension from a metadata database; and routing a response to the first extension manager, the response comprising the first and second extension configurations and an extension ranking.

### CROSS-REFERENCE TO RELATED APPLICATION

This application claims the benefit of and priority to U.S. provisional patent application No. 63/405,370 entitled SYSTEMS AND METHODS FOR TOKEN-BASED BROWSER EXTENSION FRAMEWORK filed on Sep. 9, 2022. The entire contents of this document is herein incorporated by reference.

### FIELD

The present disclosure relates to the field of computer network messaging and cybersecurity. More specifically, it relates to secure orchestration of multiple browser extensions or mobile applications to provide a cohesive web browser interface.

### INTRODUCTION

When users visit and browse websites on the internet, browser extensions may be downloaded and installed to add customized features to one or more websites. A browser extension, as a website plugin model, can enable delivery of a set of targeted content based on a number of factors including the website or domain visited, an identity of the user or visitor, and the device used by the user or visitor. It is desired to provide a harmonious user experience that balances both convenience and security.

### SUMMARY

An inter-extension messaging framework and approach is proposed for usage in improving orchestration of the functioning of computer applications, in particular, multiple mobile applications that are installed, operate or reside concurrently on a user's mobile device. The inter-extension messaging framework utilizes secure messaging to coordinate and support feature implementation, improving the operation of the mobile device through improving efficiency of service delivery, or automatically selecting between different versions of sub-modules to automatically select a most up to date version of a sub-module.

The inter-extension messaging framework coordinates the feature implementation when multiple inter-related extensions are present on a user's device, for example, being made available in browser memory, and these extensions can each have their own codebases running different sub-modules that exist in their corresponding browser extension containers. These different sub-modules provide different functionality, such as different user interfaces for rendering, different user interface elements, different versions of backend data sources (e.g., coupon dataset), among others. Sub-modules can refer to different program code sub-modules and routines, for example, function libraries that having programmatic code that can be invoked to provide computer functionality. For various reasons, such as program stability, compatibility, interoperability, the different extensions or applications could have different versions of sub-modules providing similar functionality. This can also occur as different extensions or applications are updated at various times (e.g., some users may have outdated or stale versions of applications because they do not update them regularly).

In operation, the extensions, when operating, can render or otherwise surface different interactive display elements on a user interface through injecting content through content scripts, while background processes (e.g., background scripts) interoperate in accordance with proposed approaches herein where an extension manager process handles inter-extension messaging, all of which are coordinated through event messages flowed to a backend orchestration service tracking extension metadata and returning control flow data messages to control the operation of the various extensions through their extension managers. Accordingly, the extensions can be controlled to ultimately generate and deliver a composite/hybrid page that combines certain visual elements (e.g., features) or interactive interface elements that are a combination of different features that are available in the various extensions.

This solves a technical problem that arises in respect of real-world practical applications, where a user's device can have competing versions of feature sets in different mobile applications that can, for example, be relating to a single company. There are various reasons that this can occur, such as if the user is a power user having separate applications installed for pilot programs, or is helping beta test new features. Similarly, certain mobile applications or extensions thereof may have more stable, legacy versions, and an objective may be to provide a harmonized experience for the user where the system is able to automatically engage in data message flows to securely synchronize backend operation, providing a specific technical improvements over alternate approaches which are limited by the “walled garden” technical limitations imposed by the technical ecosystems in which the applications operate within. To address some of these technical limitations, in some embodiments, a specific message exchange using Proof Key for Code Exchange (PKCE)-like mechanisms is conducted in concert with the authorization code grant flow to allow the extension to obtain cryptographic tokens (e.g., OAuth tokens), while delegating secret storage to a back-end application. The PKCE-like mechanisms are useful as a token refresh approach to store a refresh token in a secure container such as a keychain to avoid requiring users to login repeatedly when using the extension.

According to an aspect, there is provided a computer-implemented system for orchestrating at least two extensions installed on a browser, the system including: a communication interface; at least one processor; memory in communication with said at least one processor; software code stored in said memory, which when executed at said at least one processor causes said system to: receive, from a browser launched on a user device, a request from a first extension manager associated with a first extension installed on the browser, the request comprising a first extension ID for the first extension and a second extension ID for a second extension installed on the browser; retrieve, based on the first and second extension IDs, a first extension configuration for the first extension and a second extension configuration for the second extension from a metadata database; and route a response to the first extension manager, the response comprising the first and second extension configurations and an extension ranking. The extension ranking can be used for different programming logic, such as automatically selecting a most up to date version of an extension configuration, or, in another example, selecting a backup version of an extension configuration (e.g., for an attempt at exception handling).

In some embodiments, the extension ranking is obtained from the metadata database.

In some embodiments, the extension ranking comprises the first or second extension ID.

In some embodiments, the extension ranking is determined based on a set of priority rules stored in the metadata database.

In some embodiments, the response further comprises a list of domains that support the first extension or the second extension.

In some embodiments, based on the extension ranking in the response, the first extension manager is configured to be a master extension manager in control of the second extension.

In some embodiments, the first extension manager, acting as the master extension manager, transmits one or more control commands from the system to a second extension manager on the second extension manager.

In some embodiments, the transmission is encapsulated in one or more inter-extension messages.

In some embodiments, the set of priority rules comprises rules for selecting a priority extension from a plurality of extensions for a specific feature.

In some embodiments, the set of priority rules comprises user-specific priority rankings based on a user account associated with one or more of the plurality of extensions.

According to another aspect, there is provided a computer-implemented method for orchestrating at least two extensions installed on a browser, the method may include: receiving, by an extension orchestrator, from a browser launched on a user device, a request from a first extension manager associated with a first extension installed on the browser, the request comprising a first extension ID for the first extension and a second extension ID for a second extension installed on the browser; retrieving, based on the first and second extension IDs, a first extension configuration for the first extension and a second extension configuration for the second extension from a metadata database; and routing a response to the first extension manager, the response comprising the first and second extension configurations and an extension ranking.

In some embodiments, the extension ranking is obtained from the metadata database.

In some embodiments, the extension ranking comprises the first or second extension ID.

In some embodiments, the extension ranking is determined based on a set of priority rules stored in the metadata database.

In some embodiments, the response further comprises a list of domains that support the first extension or the second extension.

In some embodiments, based on the extension ranking in the response, the first extension manager is configured to be a master extension manager in control of the second extension.

In some embodiments, the first extension manager, acting as the master extension manager, transmits one or more control commands from the system to a second extension manager on the second extension manager.

In some embodiments, the transmission is encapsulated in one or more inter-extension messages.

In some embodiments, the set of priority rules comprises rules for selecting a priority extension from a plurality of extensions for a specific feature.

In some embodiments, the set of priority rules comprises user-specific priority rankings based on a user account associated with one or more of the plurality of extensions.

In accordance with yet another aspect, there is provided a non-transitory computer-readable medium having stored thereon machine interpretable instructions which, when executed by a processor, cause the processor to perform: receiving, by an extension orchestrator, from a browser launched on a user device, a request from a first extension manager associated with a first extension installed on the browser, the request comprising a first extension ID for the first extension and a second extension ID for a second extension installed on the browser; retrieving, based on the first and second extension IDs, a first extension configuration for the first extension and a second extension configuration for the second extension from a metadata database; and routing a response to the first extension manager, the response comprising the first and second extension configurations and an extension ranking.

According to still another aspect, there is provided a computer-implemented method for authenticating a user, the method may include: receiving a user request from a user device for an access token, the user request comprising a user identifier (ID) and a code challenge; validating the code challenge; upon validating the code challenge, generating a user access token and a refresh token for the user ID; transmitting the user access token and a refresh ID based on the refresh token back to the user device; receiving a token refresh request comprising a code verifier and the refresh ID from the user device; validating the token refresh request; upon validating the token refresh request, generating an updated access token and an updated refresh; and transmitting the updated access token and an updated refresh ID based on the updated refresh token back to the user device.

According to an aspect, there is provided a computer-implemented system for authenticating a user, the system include: a communication interface; at least one processor; memory in communication with said at least one processor; software code stored in said memory, which when executed at said at least one processor causes said system to: receive a user request from a user device for an access token, the user request comprising a user identifier (ID) and a code challenge; validate the code challenge; upon validating the code challenge, generate a user access token and a refresh token for the user ID; transmit the user access token and a refresh ID based on the refresh token back to the user device; receive a token refresh request comprising a code verifier and the refresh ID from the user device; validate the token refresh request; upon validating the token refresh request, generate an updated access token and an updated refresh; and transmit the updated access token and an updated refresh ID based on the updated refresh token back to the user device.

According to an aspect, there is provided a computer-implemented method for authenticating a user, the method comprising: receiving and verifying a user credential from a user device; generating a user access token and a refresh token based on a code challenge; transmitting the access token and a refresh ID based on the refresh token back to the user device; receiving a token refresh request comprising a code verifier and the refresh ID from the user device; validating the token refresh request; generating an updated access token and an updated refresh token based on the validation; and transmitting the updated access token and an updated refresh ID based on the updated refresh token back to the user device.

### BRIEF DESCRIPTION OF DRAWINGS

In the figures, embodiments are illustrated by way of example. It is to be expressly understood that the description and figures are only for the purpose of illustration and as an aid to understanding.

FIG. 1 is an example schematic diagram of a system configured to authenticate users and manage multiple browser extensions, in accordance with some example embodiments.

FIG. 2 is an example schematic diagram showing a simple client authentication process, in accordance with some example embodiments.

FIG. 3 is an example block diagram showing an extension framework within a user device browser, in accordance with some example embodiments.

FIGS. 4A, 4B and 4C show an example multi-extension orchestrator process, in accordance with some example embodiments.

FIGS. 5A, 5B, 5C and 5D show an example improved PKCE-token process, in accordance with some example embodiments.

FIG. 6 shows an example schematic diagram of a computing device that implements a user device, in accordance with some example embodiments.

FIG. 7 shows an example web browser with multiple extensions, in accordance with some example embodiments.

FIG. 8 shows an example web browser with two extensions each having an extension manager, in accordance with some example embodiments.

FIG. 9 shows an example webpage with two extensions each having an extension manager and feature list, in accordance with some example embodiments.

FIG. 10 shows an example process implemented by the system in FIG. 1, in accordance with some example embodiments.

### DETAILED DESCRIPTION

Browser extensions are customized to bring additional features to one or more websites to enhance user experience. Browser extensions, as a website plugin model, can enable delivery of a set of targeted content based on a number of factors including the website on which the extension is installed, an identity of the user or visitor, and the device used by the user or visitor.

A browser extension is a daemon process running in a web browser process. OAuth is an approach for user authentication and access to back-end/remote services hosted outside the extension. The OAuth “Authorization Code Grant” requires secure storage of a client secret. In OAuth implementation, a browser extension is considered a public client or agent, not a confidential client, and storage of client secrets in an extension is not recommended. The proposed solution uses a PKCE-like exchange on top of the Authorization Code Grant flow to allow the browser extension to obtain OAuth tokens, while delegating secret storage to a back-end application.

In a simplified example of extension orchestration, a user, Alice, has the following applications/extensions on her phone:
Online Banking (Version 6.33)
Launch (Version 7.3)
Credit Card Rewards (Version 4.6)
Direct Investing (Version 101.3.0)
Experimental Savings Platform (Version 4.50.0)

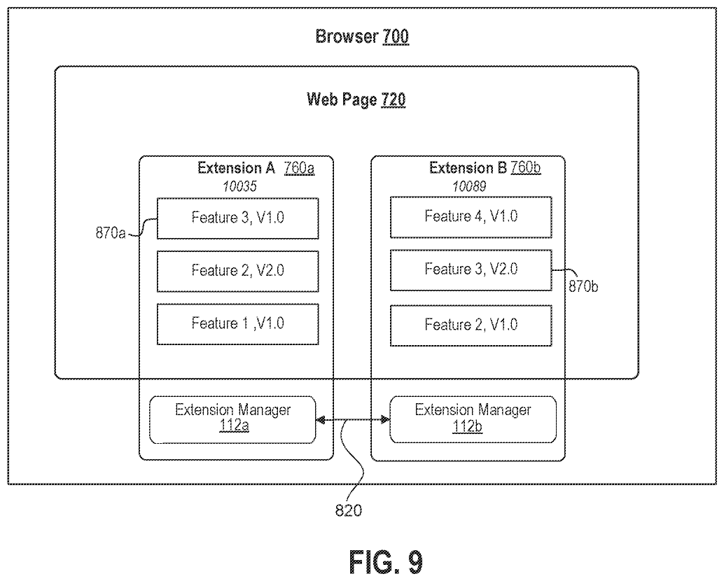

Each of these applications have a corresponding extension that interacts with Alice's Safari browser, and each has different submodules having code subroutines for conducting various enhanced functionality on the webpage (see FIG. 9, Extensions A, B). Each of the applications have different feature sets at different versions, as shown therein.

Since every customer has the Online Banking application, it is designated as the main extension orchestrator. Accordingly, the extension orchestrator process operates in the online banking extension, which coordinates the extension sub-functionality to (1) avoid conflicting extension functionality, (2) provide an improved composite functionality for Alice, and/or (3) allow for concurrent redundant versions to utilized in the event of a sub-routine fault.

At various times (or based on a triggered event, such as the install/update/removal of a related application or extension), the various extensions register with one another or register with a main extension (e.g., online banking in this example), such that the extensions are now able to identify one another and their corresponding underlying functionality. The extensions, for example, can provide a listing through a JSON or XML file indicating their capabilities that are ultimately stored as extension metadata by an extension orchestrator (e.g., simplified as the extension ranking). The registration process is conducted through the usage of secure tokens, which are exchanged during the registration process as part of inter-extension messages. The secure tokens can be generated based on an existing access credential of the user, such that each of the tokens can thus be used for establishing secure communication pathways between extensions. These messages can be passed between extensions, for example, using universal links having payloads as sent through an application programming interface that can be made available through each of the extensions.

After registration, the extension orchestrator, for example, can store the related metadata. The non-active extension manager extensions can be set to “relay mode” to forward control to the main extension manager.

When the extensions are invoked (e.g., through webpage hooks or triggers as indicated through an interrogation of the DOM), the extension orchestrator identifies the trigger as an event flow. An event flow message could, for example, be a JSON message having certain characteristics or fields, and it could be sent from any of the extensions, or a combination of the extensions. An example extension trigger can include, for example, a checkout page having a hook where different “in line” offers can be shown to the user. The extensions may compete or complement one another by determining what type of offer to show, based on injected content scripts.

In some embodiments, the extension orchestrator receives a plurality of event flow messages from different available extensions having requisite capabilities and compares the event flow messages to determine a priority sequence or combination or extension capability to be surfaced for creating the injected content script to respond to the event. This comparison/priority sequence could operate, for example, by conducting a comparison based on the requested functionality, and in some case, may have multiple extensions trading inter-extension messages to combine the types of potential data elements to be surfaced. For example, if there are two extensions each with their different underlying offer databases, both of the extensions have offer databases can be interrogated to identify the most relevant offer to be provided in the in line offer visual element in the injected content script.

In this example, an injected content script could have a set of schema and data, which includes the corresponding extension managers A and B interoperating through inter-extension messages, and when the injected content script is triggered, it could pull from the data sources of both extensions A and B to provide a unified experience. Finally, the specific code for rendering the injected content script, if there are overlapping extension functionality, can be based on a latest version of the graphics rendering as identified in the extension metadata (e.g., graphical button elements, interactive content type, style sheets, font sets). Conversely, it can also use a redundant version instead if there is a thrown except or fault, or a determined incompatibility.

From Alice's perspective, when she loads the checkout page, she is able to see an in line offer presented in a UI section that seamlessly takes into account the different applications or extensions that are loaded onto her phone. These can include combinations of offers from different data sets or sources that are most relevant to Alice. The inter-extension messaging is securely conducted using the tokens so that a malicious third party application eavesdropping on the message flow is unable to obtain Alice's sensitive information.

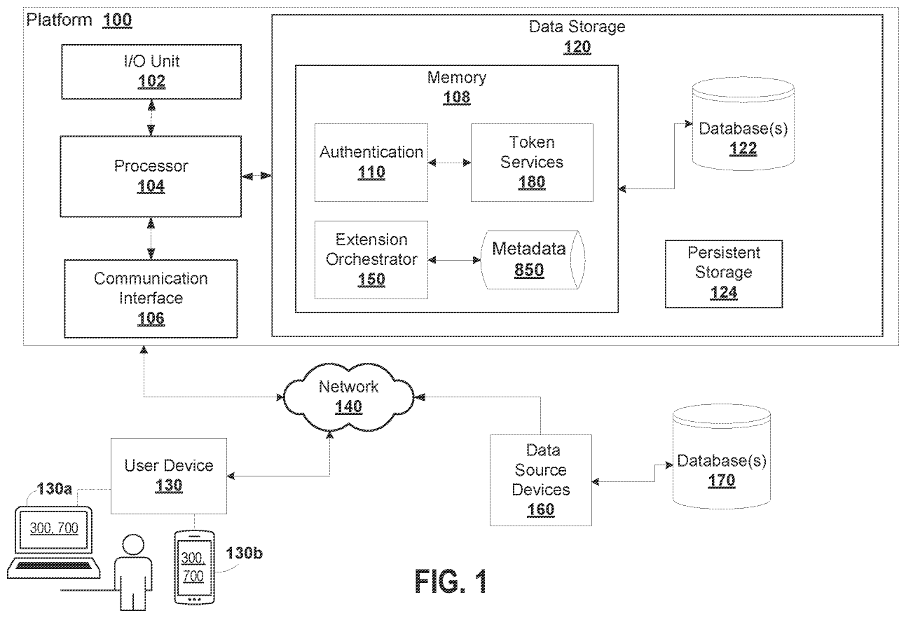

FIG. 1 is a schematic diagram of an example computer-implemented system or platform 100 for authenticating a user/a user's device when he or she visits a web browser that has at least one extension installed, exemplary of embodiments.

A user's device, for example, can have different extensions that can be operable either on the same or different mobile applications, and each of these extensions can have sub-modules supporting different features. These are coding sub-modules that can reside in memory, and may, in some cases, provide overlapping features, albeit at different versions providing different levels of support (e.g., bug-fixes), or capabilities. Another useful implementation of the approach described herein is also for usage of different redundant versions in the event that a particular version of a functionality doesn't work or encounters a bug or unhandled exception. As part of handling the fault, a variation may include automatically negotiating the usage of a prior version of a function as found in another application or extension.

There are different situations where a user could have different extensions with overlapping functionality, and this can occur, for example, in the context of different mobile applications that are provided in respect of a financial institution. While most financial institution customers could have a main application or extension adapted for online/mobile banking, a subset of financial institution customers could be users who are deemed “power users”, and have installed an additional set of applications or extensions that are used for different additional features, such as insurance management, online trading, etc. Finally, there may be another potentially overlapping subset of financial institution customers who are users interested in new products of the financial institution, such as advanced couponing engines, automobile purchasing engines, etc., and this subset of financial institution customers could also have a further additional set of applications or extensions.

Accordingly, the user device may have a number of different applications or extensions that have some overlapping feature sets that co-exist with one another in memory, and there is an opportunity to improve the user's experience through being able to surface or render a combined set of composite functionality from each or some of the different applications or extensions such a hybrid experience is established. A technical challenge to be overcome is ensuring that the coordination of the different applications or extensions is able to occur due to the technical limitations imposed with respect to application or extension segregation, for example, due to cybersecurity containerization limitations enforced by an operating system, among others.

As described herein, the applications or extensions are specially configured in the proposed approach to add an inter-messaging sublayer that interacts, through background data processes (e.g., individual extension manager sub-modules) through to a coordinated orchestration service that manages extension metadata. In some embodiments, if there is no coordinated orchestration service available in the absence of any mobile applications or extensions, one approach is to have the coordinated orchestration service available always available in the application that is always present (e.g., online banking for a financial institution). In another embodiment, if there is no application that all users would have, another variation is to have copies of the coordinated orchestration service provided on every mobile application or extension. A further variation on this embodiment is to have the mobile application or extension having the latest version of the coordinated orchestration service be nominated as the “driving” coordinated orchestration service. If two or more coordinated orchestration service instances have the same version, one of the coordinated orchestration services can be selected through, for example, random number generation. This is useful in situations where a user has multiple related applications or extensions installed and the system has the benefit of being able to effectively draw from the combined available functionality and sub-functionality available across all of them. This can be used in different practical contexts, such as rendering the most up to date GUI experience (e.g., the latest style-set), providing a most up to date combined set of available offers or promotions, allowing the switching of a sub-function to allow for improved fault handling capabilities (e.g., an ability to overcome a fault by using a prior version of a function), or overcoming certain faults associated with out of date versioning by using a different, latest version of a function. For example, a user may be using a browser having a stable online banking application extension thereon, and a newer credit cards rewards program extension. When the rewards program extension function throws a rendering fault or exception, the extension orchestrator can automatically attempt the same functionality using redundant sub-functionality of the online banking application as a mechanism for improved exception handling. This is an improvement over the application simply crashing in an ungraceful manner. This is particularly useful in practical environments where there is a diverse set of devices being used with different firmware and operating system versions (e.g., some users are on OS version 6.1, others are on 6.1.2, while some are still on 5.0.3 because they have old smartphone that are not supported any more), as each change by manufacturers can unintentionally cause faults in application programming. The browser extension orchestration allows for a coordinated ability to be more resilient to external programming faults.

System or platform 100 has data storage 120 including a memory 108, a local database 122, and persistent storage 124. Memory 108 includes at least three instruction modules stored thereon, namely, authentication module 110, token services 180 and extension orchestrator 150. Memory 108 may also include a metadata datastore 850 (also referred to as a metadata database 850) connected to extension orchestrator 150. In some embodiments, metadata datastore 850 may be part of database 122.

A processor 104 is configured to execute machine-executable instructions to authenticate users via authentication module 110 and token services module 180, or to manage multiple extensions via extension orchestrator 150 and metadata store 850.

The system 100 can connect to an interface application installed on a user device 130 to receive input data. The interface application interacts with the system 100 to exchange data (including control commands) and generates visual elements for display at user device. The visual elements can represent user authentication interface or web browser elements. The user device 130 may be for example, a computer or laptop 130a, or a mobile device 130b. The computer or laptop 130a or a mobile device 130b may have a web browser application installed hereon, which can launch web browser 300, 700.

The system 100 connects to different data sources 160 and databases 170 to receive input data and receive output data for storage. The input data can represent static or dynamic content delivered via browser extensions for a particular website the user is visiting, for example. Network 140 (or multiple networks) is capable of carrying data and can involve wired connections, wireless connections, or a combination thereof. Network 140 may involve different network communication technologies, standards and protocols, for example.

The system 100 includes an I/O unit 102, a processor 104, communication interface 106, and data storage 120. The I/O unit 102 can enable the system 100 to interconnect with one or more input devices, such as a keyboard, mouse, camera, touch screen and a microphone, and/or with one or more output devices such as a display screen and a speaker.

The processor 104 executes instructions in memory 108 to implement aspects of processes described herein. The processor 104 can execute instructions in memory 108 to configure a data collection unit, interface unit (to provide control commands to interface application of user device 130), authentication module 110, token services 180, extension orchestrator 150, and other functions described herein. The processor 104 can be, for example, microprocessors or microcontrollers, a digital signal processing (DSP) processor, an integrated circuit, a field programmable gate array (FPGA), a reconfigurable processor, or combinations thereof.

The memory 108 may include a combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM). Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The system 100 can be operable to register and authenticate users (using a login, unique identifier, and password for example) prior to providing access to websites, browser extensions, applications, a local network, network resources, other networks and network security devices. For example, user authentication process may be handled via the authentication module 110 and token services module 180, as further elaborated below.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

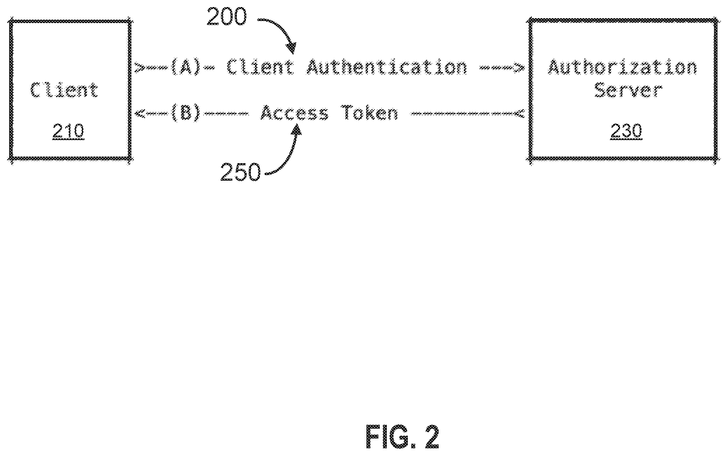

FIG. 2 is an example schematic diagram showing a simple client authentication process, in accordance with an embodiment. A browser extension is a daemon process running in a web browser process. OAuth is an approach for user authentication and access. In OAuth terms, a browser extension is considered a public client or agent, not a confidential client, and storage of client secrets in an extension is not recommended.

In some embodiments, the disclosure provides a method for provisioning a browser extension with access to secure server APIs via the OAuth 2. Client Credentials Flow shown in FIG. 2. A client 210 may be for instance, an application installed on user device 130. It may be for example, a browser extension on a web browser application installed on user device 130. Client 210 may receive user input for accessing one or more secure content. The client 210 may communicate with authorization server 230 to obtain the requested access based on an authentication process 200 involving an access token 250.

The Client Credentials grant type is used by clients 210 to obtain an access token 250 outside of the context of a user. The access token 250 is typically used by clients 210 to access resources, such as content provided by one or more browser extensions. The access token 250 can be obtained by going through a client authentication process 200 with the authorization server 230. The authorization server 230 may be, for example, a server executing the authentication module 110, which may be part of system 100. The authentication module 110 may communicate with token services 180 and other components of system 100 to authenticate a user based on a token access process.

For instance, the client 210 may authenticate with the authorization server 230 and requests an access token 250 from the token endpoint. After the authorization server 230 authenticates the client 210, and if valid, the authorization sever 230 can issue an access token 250.

The Client Credentials flow is commonly used in machine-to-machine contexts. Authentication process 200 typically requires a Client ID and Client Secret, thus this particular flow is restricted to “Confidential Clients” that can securely store the Client Secret.

As browser extensions are generally considered public clients, not confidential clients, storage of Client Secrets or client credentials in an extension application is not recommended. Therefore, a PKCE token access and refresh process is utilized for browser extension applications.

PKCE refers to the standard Proof Key for Code Exchange, and a PKCE process addresses specific weaknesses in the OAuth Authorization Code Grant flow.

In some embodiments, the authentication module 110 and token services module 180 executed by the system 100 re-purposes PKCE features to support use of refresh tokens in a public client (e.g. a browser extension application).

For example, the authentication module 110 on system or platform 100 may be implemented to use a proxy server as an intermediary to handle the Client Credential flow on behalf of a public client, which may be a browser extension.

First, the client, which may be a browser extension instance in running, can send an access request to a server-side proxy that acts as the Confidential Client. The proxy may be responsible for storing the Client Secret. The access request can be built on a web user sign-in process, which may be a username and password, a two-factor authentication process, and/or a login process via a social media application. Once the user identity has been property verified or validated, access tokens may be generated and granted for use by the browser extension. Access tokens may need to be refreshed via a token refresh process from time to time, as each access token is only valid for a short duration of time.

In some embodiments, a Code Verifier/Code Challenge pair, similar to the PKCE approach for Authorization Code Grant, is used to validate and authorize token refresh requests.

In some embodiments, the Code Challenge and Challenge Method can be submitted with the access request, and stored by the authorization server 230. The Code Verifier must be provided when a token refresh call is made, and the authorization server 230 can authorize the request using the PKCE Challenge/Verifier validation process.

In some embodiments, the disclosed refresh token code flow works so that a user does not have to log into his or her account often, especially in an environment where multiple extensions are accessing backend APIs to figure out which features or overlays system 100 or external database 170 has for a particular website 310.

Typically, access tokens 250 have about a few hours of validity period, where refresh token has between a few months to a year of validity duration. Refresh tokens, which may be identified by refresh IDs, can be stored or cached in a relatively non-secure area e.g., local storage or cache of a browser. When a user uses the refresh token, the client 210 sends the code verifier stored relatively privately on the user device to authorize request to get a refresh token or refresh ID.

In some embodiments, system 100 is configured to implement a token refresh code flow by: receiving and verifying a user credential from a user device; generating a user access token and a refresh token based on a code challenge; transmitting the access token and a refresh ID based on the refresh token back to the user device; receiving a token refresh request comprising a code verifier and the refresh ID from the user device; validating the token refresh request; generating an updated access token and an updated refresh token based on the validation; and transmitting the updated access token and an updated refresh ID based on the updated refresh token back to the user device.

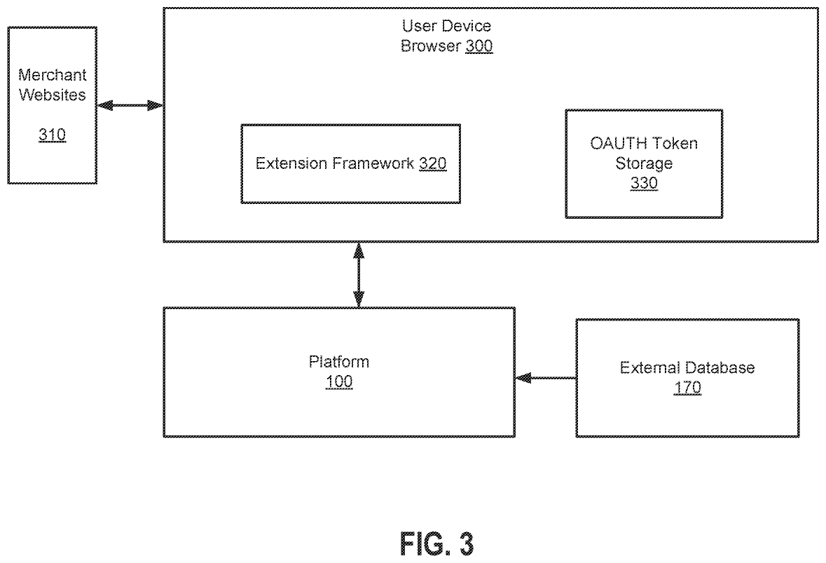

FIG. 3 is an example block diagram showing an extension framework 320 within a user browser 300, in accordance with an embodiment. As can be seen, a user browser 300 may have an extension framework 320 (e.g., one or more extensions installed thereon and managed by extension orchestrator 150) and an OAuth token storage 330. Each extension on a browser 300 may be managed by a respective extension manager for the extension. The user browser 300 visits one or more merchant websites 310, and based on the particular website 310 visited, the extension framework 320 may talk to the extension orchestrator 150 in order to determine which extension application, in the case of multiple extensions being installed on user browser 300 for the website 310, is going to take priority in delivering content to the user browser 300.

In some embodiments, the system or platform 100 communicates with an external database 170 in order to retrieve one or more dynamic content to the user browser 300.

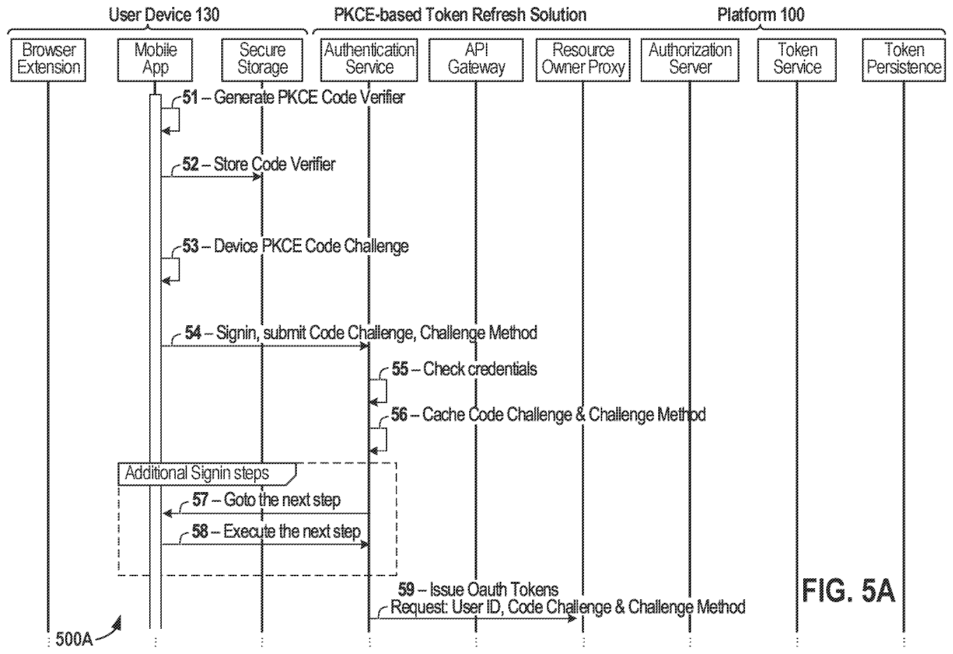

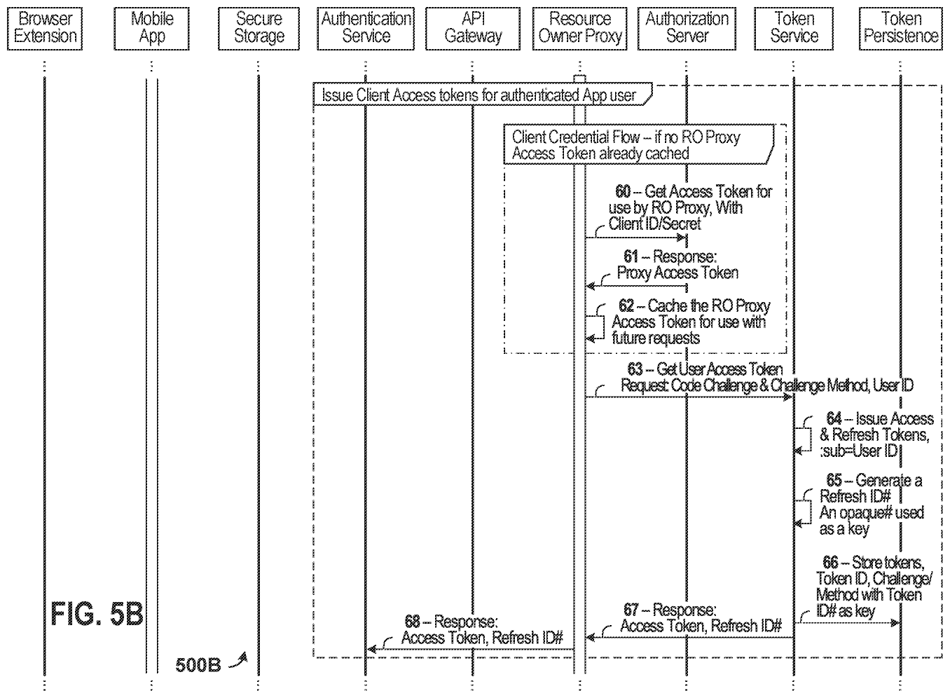

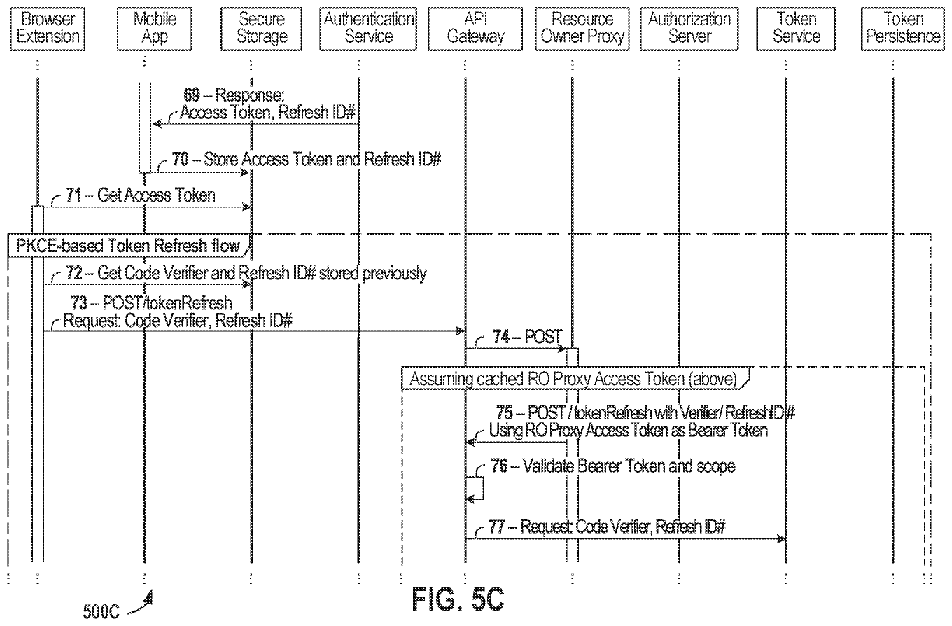

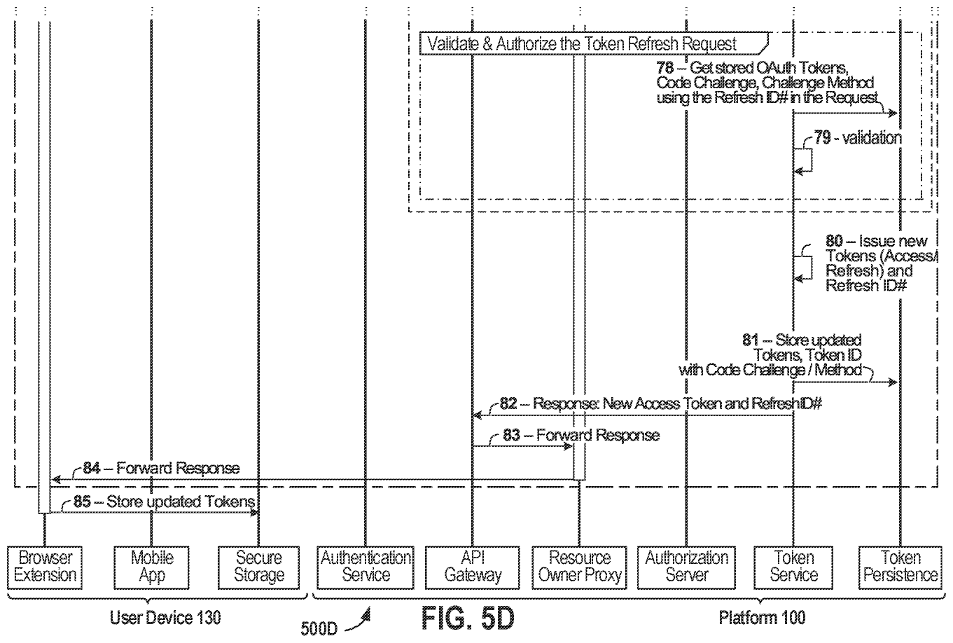

The OAuth token storage 330 is used to store access tokens 250 and refresh IDs, if needed, in accordance with the process illustrated in FIGS. 5A to 5D, which show an example improved PKCE-token process 500A, 500B, 500C, in accordance with an example embodiment.

A mobile device, which may be user device 130, has a mobile application that may act as a client that can generate PKCE code verifier, and stores the code verifier in a secure storage on the device. The Code verifier may be a high-entropy cryptographic random sting with a minimum length of 43 characters and a maximum of 128 characters.

The PKCE code challenge may be generated using SHA256.

After the user login process, the user credentials, along with code challenge, challenge method are sent to authentication service for verification. Once verified, the code challenge and challenge method may be stored.

The authentication service may then issue an access token request with user ID, code challenge, and challenge method to a resource owner proxy server, which may issue client access tokens for authenticated mobile app user.

As part of the access token generation process, both access token and refresh token may be generated for the user ID associated with the authenticated mobile app user. A refresh ID may also be generated for the refresh token, A refresh ID may be a random sequence of number and characters. The actual refresh token is not sent to the client app, and instead, only the refresh ID, along with the access token, is sent back to the resource owner proxy, which then relays the access token and refresh token to the authentication server, which then sends the same to the mobile app.

The mobile application that has received the access token and refresh ID then stores the access token and refresh ID, along with code verifier, on local storage. The browser extension can use the access token provided by the authentication process until it expires. The access token is used as a bearer token for application API calls. However, when the access token, which has a relatively short lifespan or validity period, has expired, a token refresh code flow is executed.

In some embodiments, as part of the token refresh code flow, the browser extension get code verifier and refresh ID stored previously to the resource owner proxy. The resource owner proxy can first try validating bearer token, and sends a request including a code verifier and a refresh ID to token service module 180 for token refresh. The token service module 180 gets stored OAuth token, code challenge, challenge method, and use the refresh ID in the request to validate the refresh token and the bearer/access token.

The token services module 180 can apply the code challenge method to code verifier, compare the result with the stored code challenge, and if validated, issue new tokens and refresh ID. The token service module 180 stores the updated token, token ID with code challenge and method securely, and sends the new access token and refresh ID back to resource owner proxy, which sends the same to the browser extension for storage and future use.

In some embodiments, DSL (domain-specific language) script may be implemented and executed to enable dynamic behaviour of one or more extensions. The DSL script may use constraints built into DSL to download a core set of code that will execute the DSL scripting language, access backend metadata that drives the DSL, and provide a dynamic user experience based on backend APIs.

### Multi-Extension Management—Browser Extension Orchestrator

Where multiple extensions target the same websites and feature space, user experience can suffer due to conflicting or duplicated extension logic, which may be written in DSL. When potentially conflicting extensions are provided by the same organization, there is a need to rationalize the expression of overlapping code and features to optimize the user experience. The delivery model of extension applications, via an App store, is often restrictive in terms of supporting new features and new third party websites. In another variation, the rationalization of the logic can be used to provide an improved and optimized experience through enhanced error resilience and exception/fault handling by orchestrating the extensions to utilize different versions of code in a first attempt at handling the issue.

In some embodiments, a Browser Extension Orchestrator 150, which is configured for delivery of a cohesive, branded user experience that is presented in the form of multiple, independently-installed browser extensions. As noted, this context arises in situations where one or related parties offer independent installations of different applications or extensions that have some overlapping functionality. For example, for a financial institution, the financial institution may have different lines of business and each line of business can offer different applications or extensions to install (e.g., a core online banking product that every customer has, then a power user trading platform, a credit card rewards program, a vehicle tracking platform, an insurance platform, a student offers/discounts platform, a seniors discounts platform, and a new/experimental technology platform).

Browser extensions 760a, 760b are customizations to browser functionality provided by third parties. Users may install an arbitrary number of extensions in their browsers 300, 700.

An extension may be executed in the form of content script that runs in the context of a particular webpage. Background scripts can access all the WebExtension JavaScript™ APIs, but they can't directly access the content of webpages. Similar to the scripts loaded by normal webpages, content scripts can read and modify the content of their pages using the standard DOM APIs.

Content scripts can only access a small subset of the WebExtension APIs, but they can communicate with background scripts using a messaging system, and thereby indirectly access the WebExtension APIs.

When a browser application with two extensions “A” and “B” installed in browser 300, 700, visits a website 310, both extensions may inject additional script code to enhance the page and user experience in some way.

The two extensions are, in principle, unaware of each other, and the browser controls execution order of the extension code.

Organizations may offer multiple browser extensions for a given platform, for any number of reasons. For example on the iOS™ platform, browser extensions must be bundled with an iOS™ native app and delivered through the App store. To ensure maximum exposure, an Organization with multiple, complimentary mobile apps may choose to provide their extension with each of their native apps.

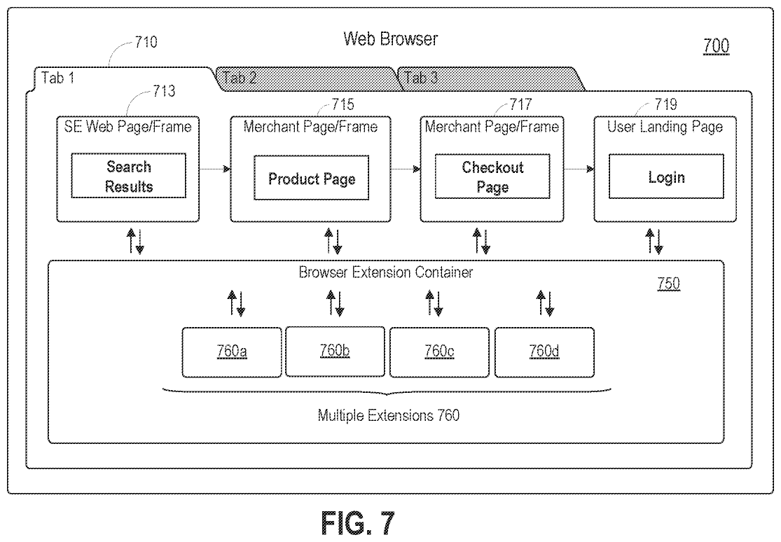

FIG. 7 shows an example web browser 700 with multiple extensions 760, in accordance with some example embodiments. A browser 700 may has multiple tabs 710 open, and one active tab 710 may visit multiple webpages 713, 715, 717, 719 in a sequential order. For example, search results may be displayed at a first webpage 713, then a product page 715 may be launched upon being clicked or tapped by user, the user may then proceed to a checkout page 717, and then, as part of a checkout process the user has to log into a user account at a user landing page 719. Throughout the whole process, a browser extension container 750 within web browser 700 may have multiple browser extensions 760a, 760b, 760c, 760d actively listening at each webpage. For example, a first browser extension 760a may be an extension from the user's financial institution application, and a second browser extension 760b may be an extension actively looking for coupons applicable to each product being browsed. A third browser extension 760c may be an extension that can simplify the checkout process by preloading the user's previously stored credit card information and delivery address.

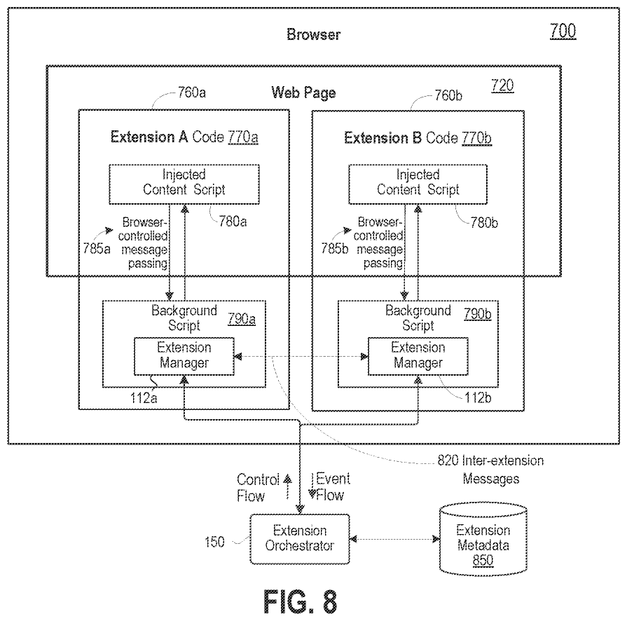

FIG. 8 shows an example web browser 700 with two extensions 760a, 760b each having an extension manager 112a, 112b, in accordance with some example embodiments.

In each browser extension 760a, 760b, code 770a, 770b, includes content scripts (e.g., JavaScript™ files) that run in the context of webpages and modify the content of a page or interact with the page's Document Object Model (DOM). For example, extension codes 770a, 770b can inject content script 780a, 780b into the webpage 720. Injected content script 780a, 780b can communicate with a corresponding background script 790a, 790b via browser-controlled message passing 785a, 785b. Scripts and data in this tier share a common browser context, accessible by the host domain (e.g. Merchant or Payment Service Provider).

In some embodiments, content and background scripts 790a, 790b includes a module for a respective extension manager 112a, 112b, which can communicate with one another through inter-extension message passing 820.

In some embodiments, extension orchestration via extension orchestrator 150 is configured to allow multiple extensions 760a, 760b to act as a single virtual extension (e.g., extension framework 320) using various supported forms of inter-extension communication. Essentially, the orchestration controls the operation of the extension code so that they operate in concert based on instruction commands from the orchestrator 150. Accordingly, the combined functionality of all of the extensions can be made advantageously available to the orchestrator 150, which can be used to improve the overall functioning of the extension. The orchestrator 150 can also pre-emptively identify conflicts and prevent/resolve race conditions from occurring, which is useful in achieving an overall unified experience.

One example orchestration mechanism implemented by extension orchestrator 150 allows routing of messages between the server-side orchestration service and each extension managers 112a, 112b. The orchestration service sends extension control metadata that determines which features, e.g. which content scripts, from which extension instance, and in what order, should be displayed for a given webpage 713, 715, 717, 719, 720. The metadata may be stored or retrieved from metadata datastore 850. This metadata can be stored in a data structure at a data storage of extension orchestrator 150 such that the metadata can be used to provide a “map” that the extension orchestrator 150 can traverse periodically to determine the optimal combination of functions to ultimately surface for the user interface. Similarly, in some embodiments where the orchestrator 150 is also being used for fault handling/error resilience, the metadata is also useful to provide backup functionality to be accessed as an attempt for resolving a thrown exception.

In an example embodiment, an extension manager 112a, 112b is configured to submit an embedded extension ID and version string when making metadata requests via the extension orchestrator 150. For example, in JSON language, the metadata request may include:

{“extId” “7ab5a622-8634-4ab1-b3b9-fd39958d3abc” “version” “1.0” . . . }

the id and version string are used to ensure the user experience reflects the best available content as browser extensions are installed or upgraded.

A feature may refer to a functionality, a set of content, or a set of content script triggered by one or more events happening at a web browser 700 (e.g., at an active webpage 720). In some embodiments, in a given orchestrator model, content scripts are organized as versioned features, as shown in FIG. 9. The orchestration allows the configuration of features to be assigned, per browser type and browser version (e.g. Windows Desktop Chrome v100) in the metadata database. For instance, a feature may be rendering and displaying of customized content for a user via a browser extension. A user browsing webpage 720 may have both extension A 760a and extension B 760b installed on the browser 700 and both offering the same feature or similar content, or the extensions may offer conflicting content for the same event trigger. In any event, extension orchestrator 150 and extension managers 112a, 112b inter-operate in the background in negotiating and executing an event flow that presents a seamless user experience, based on a set of priority rules stored in metadata database 850.

In some embodiments, each extension 760a, 760b is associated with a respective extension ID, e.g., extension A 760a has an ID “10035” and extension B 760b has an ID “10089”. The extension ID may be used to track various versions for each feature. A set of priority rules can be implemented, for example, through JSON configuration files stored in metadata database 850, the priority rules includes a set of logic indicating how and what features are going to be surfaced or used in providing services to a user browsing the webpage. The set of priority rules can be extended to things like available payments, delivery address, offers and coupons.

In some embodiments, when both extensions share similar features with different versions, an example default priority rule may be that an extension with a higher numbered version may be set as the priority or master extension. In FIG. 9, for example, each extension 760a, 760b may be associated with one or more feature and versions 870a. For a given feature, such as Feature 3, extension B 760b having a higher version 870b may be determined to be the master extension over extension A 760a having a lower (or none) version of the same feature. The list of features and versions of each feature associated with each extension 760a, 760b may be stored in metadata store 850, and communicated to each of extensions 760a, 760b vias a control flow by the extension orchestrator 150 of system 100. The default priority rule may yield to other priority rules that may apply in one or more specific scenarios.

In some embodiments, the set of priority rules may further include logics or priority rankings for orchestrating different features for different users. For example, for user Adam with both extensions installed, when Feature 2 should be surfaced for the user within webpage 720, extension B with Feature 2, V1.0 may be selected based on the priority rules to surface Feature 2, even though extension A may have a higher version (V2.0) of Feature 2. This may be due to, for instance, compatibility issues with other active plugins running in the background, which is tracked by the extension orchestrator 150 of system 100.

As further elaborated below, extension managers 112a, 112b utilize inter-extension messaging in an inter-extension messaging protocol to coordinate activities as between the different applications or between different features for the same application. The extension managers and their inter-extension messaging protocol overcome technical limitations resulting from different “walled” approaches taken to segment or segregate applications by the various operating ecosystems (e.g., iOS™).

The configuration and metadata in metadata store 850 can be updated without shipping a new version of the extension code.

### Advanced Orchestration

Certain feature types can also be added to the extension dynamically, through downloading of metadata scripts in a control flow the extension orchestrator 150 of system 100. As dynamic downloading of Javascript™ code to an extension could undermine browser security, metadata scripts can be created using a highly constrained Extension Orchestrator Domain Specific Language (“DSL”).

The Extension DSL supports, for example:
Dynamic definition of content-script overlays for visual features. Extraction of page data including form data.
Handling of page events
Filling of form data
Generation of new events and event forwarding rules. API calls to the Extension Orchestrator host domain

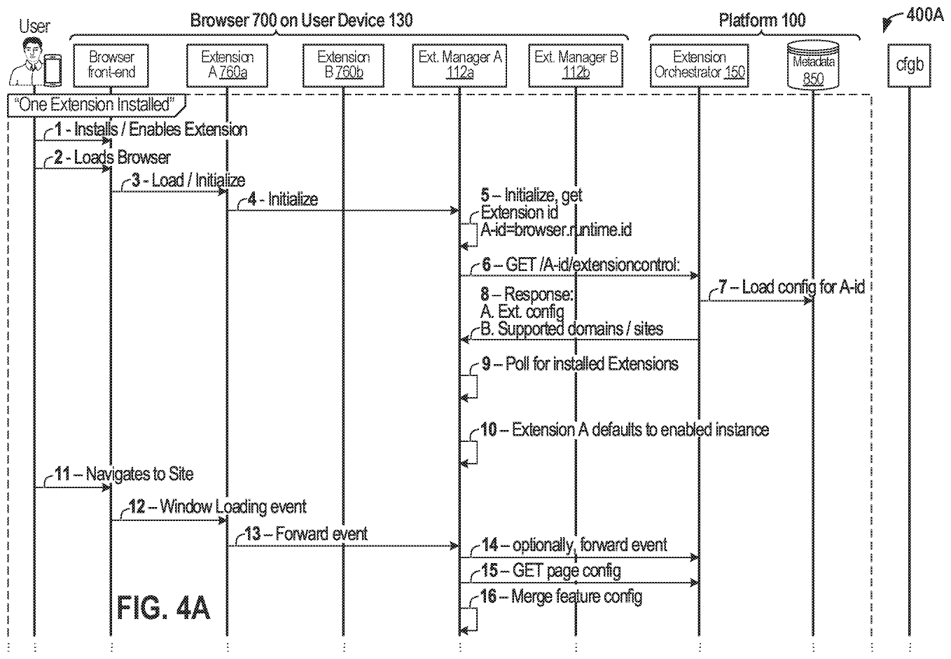

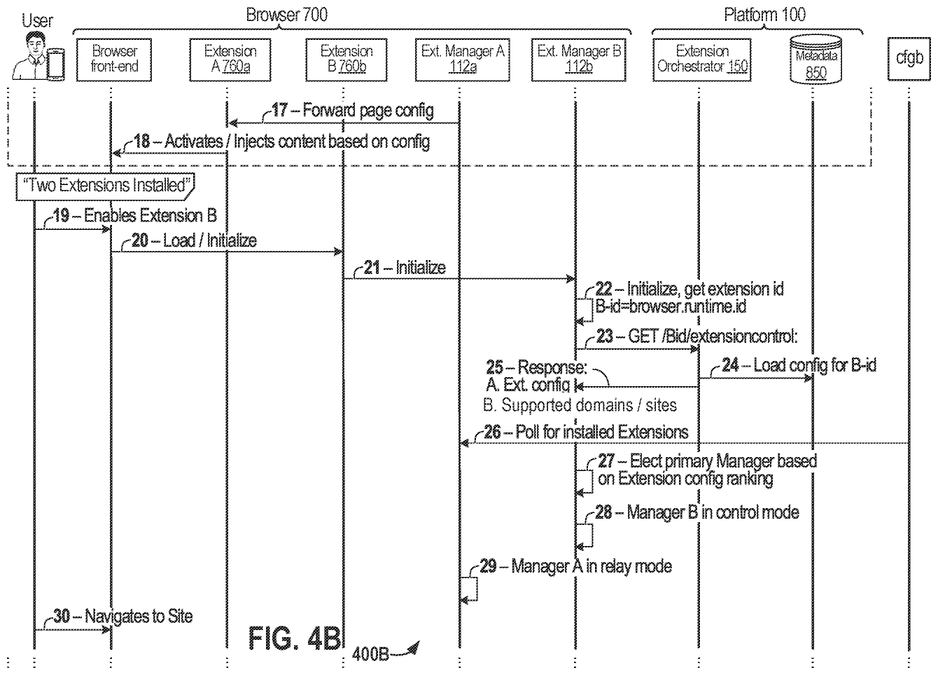

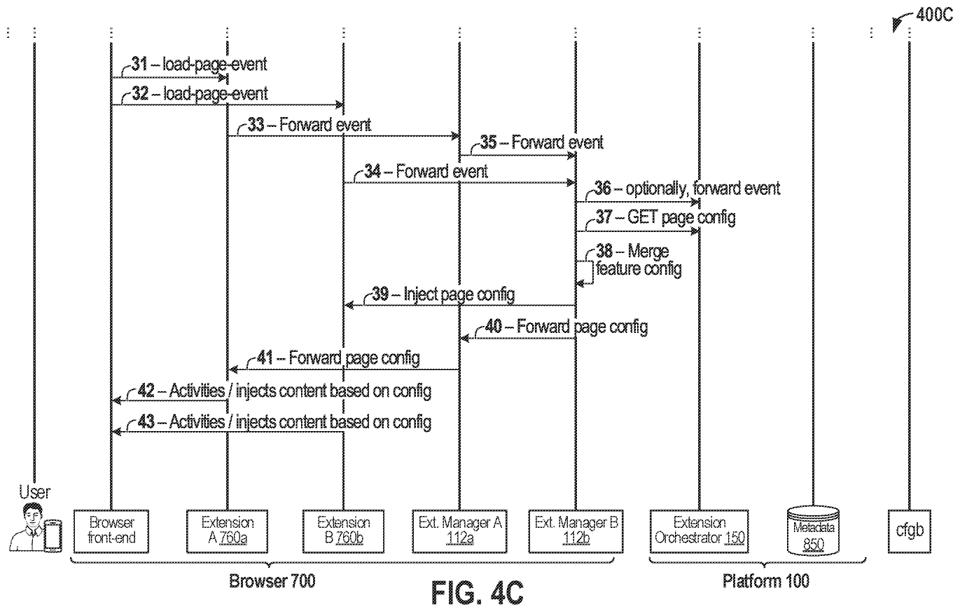

FIGS. 4A to 4C illustrates a scenario where one or two extensions 760a, 760b are installed on a web browser 700 on a user device 130, each having a respective extension managers 112a, 112b. The first extension, extension A 760a, has an extension manager A 112a. The second extension, extension B 760b, has an extension manager B 112b.

### One Extension Installed

Extensions are event-based processor-readable instructions used to modify webpage, or enhance a web browsing experience. Events can be for example browser triggers, such as navigating to a new page, initiating a checkout process, or closing a tab. Extensions monitor these events in their respective background script, then based on a specific event occurrence, react with specified instructions.

Referring now to FIG. 4A, steps 1 to 18 of diagrams 400A and 400B refer to a first flow that occurs when only a single extension, extension A 760a, is first enabled or installed onto a web browser 700 (step 1). When webpage 720 in the browser 700 is loaded at step 2, the browser first loads extension A 760a at step 3. Extension A 760a then initializes and calls extension manager A 112a at step 4, which helps configure and control various aspects of the extension's behaviour.

As extension manager A 760a is initialized at step 5, it sets various context elements, including for example setting the identifier of the extension, and a current runtime identifier assigned by the browser. Extension manager A 112a then makes a request to the extension orchestrator 150 at step 6; this is a service running on a server, accessible to all extensions, in some embodiments by making API requests.

In some embodiments, the request made will be a HTTP GET request. The extension orchestrator 150 in response to receiving the HTTP GET request from extension manager A 112a, loads configuration for the extension from a metadata database 850 also running on the server at step 7, and then responds to the request from extension manager A 112a at step 8 with relevant configuration settings, including extension configurations such as features and versions, and domains that support the extension.

Once the configuration has been received and set, extension manager A 112a at step 9 will then proceed to poll for installed extensions, via for example inter-extension messages 820 in order to determine whether any other extensions are installed in the browser. When there are no other extensions, extension manager A 112a will default itself to the enabled extension for all supported sites, as indicated in the response data from the extension orchestrator 150.

In the one-extension flow, as the user device 130 directs the browser 700 to navigate to a website at step 11, the browser sends along a window loading event to extension A 760a at step 12. This is forwarded to extension manager A 112a at step 13, which may optionally forward the event to the extension orchestrator 150 at step 14.

In some embodiments, extension manager A 112a can retrieve a website-specific page configuration from the extension orchestrator 150 at step 15, and merge with its current feature configuration, as set during initialization. Continuing onto diagram 400B in FIG. 4B, Extension manager A 112a then at step 17 returns the page configuration (with feature merged) to extension A 760a, which can at step 18 activate content on or inject content into the webpage, as appropriate.

### Two or More Extensions Installed

In the case of two extensions, extension manager B 112b for extension B may be determined to be the master extension, that is, extension manager 112b for extension B may be in control mode, while extension manager 112a for extension A may be in a relay mode. When the user visits a particular website 310 or webpage 720 for which both extensions apply, extension manager A 112a may simply forward event to extension manager B 112b, and extension B 112b may forward page configuration to extension A 112a, which further activates or injects content to the website 310 or webpage 720 based on the page configuration.

In this flow, extension B 760b is installed in addition to extension A 760b, onto the user's web browser. For simplicity of explanation, the following assumes that extension A 760a has already been installed on the user's web browser, and that there are two extensions installed. By analogy, the described process will continue to work in cases where more than two extensions have been installed.

When extension B 760b is first enabled or installed into the browser at step 19, or whenever the browser is loaded after extension B has been installed, it proceeds through the same initialization process as with extension A. First, the browser loads extension B 760b at step 20. Then, extension B 760b calls extension manager B 112b, which, as with extension manager A, is a library of processor-readable instructions included with the extension, that is used to help configure and control various aspects of the extension's behaviour. Extension manager B 112b is initialized at steps 21 and 22, by setting for example various context elements. Extension manager B then at step 23 makes a request to the extension orchestrator 150 for extension control. The extension orchestrator 150 at step 24 loads configuration for the extension from the metadata database 850 running on the server, and will then respond to the request from extension manager B with relevant configuration settings at step 25, including relevant extension configurations for both extensions A and B, and domains that support the extension.

Extension A 760a at this point will have similarly initialized itself, as described in the one-extension case, and both extensions will then poll for other installed extensions at step 26. Both extensions, upon polling, will be notified that the other is also running on the browser. Various processes at step 27 may then be used to determine which extension manager, as between extension manager A 112a and extension manager B 112b, will become the active extension manager. An example may be through configuration data of features and version as obtained from metadata database 850 that rank the extension based on a given feature. In this case, extension manager B 112b at step 28 is determined to be the primary or master extension manager.

With extension manager B 112b set to be the active extension manager, extension manager A 112a configures itself to run in relay mode at step 29, in which it will forward control to extension manager B upon receiving requests from extension A 760a, where appropriate. Extension manager B 112b will continue to receive and respond to requests from extension B 760b, and so becomes, in effect, the manager for both extensions.

In the multiple-extension flow, continuing onto FIG. 4C, whenever the user device 130 directs the browser 700 to navigate to a website at step 30, the browser will send along load page events at steps 31 and 32 to both loaded extensions, extension A 760a and extension B 760b. Each of extension A 760a and extension B 760b will forward these events to its respective extension manager 112a, 112b at steps 33 and 34, but extension manager A 112a, operating in relay mode, will forward its event to extension manager B 112b at step 35. Extension manager B will then, similarly to the single-extension case, optionally forward this event to the extension orchestrator 150 at step 36, before getting a website-specific configuration from the extension orchestrator 150 at step 37. This website-specific page configuration can be merged with the feature configuration set during initialization by extension manager B 112b at step 38. Extension manager B 112b at step 39 then forwards the page configuration to extension B 760b directly for injection of page configuration, and at step 40 forwards the page configuration to extension manager A 112a acting in relay mode. Extension manager A 112a then forwards the page configuration to extension A 760a at step 41. Each extension 760a, 760b can then, as appropriate based on the page configuration, activate content on or inject content into the webpage at steps 42 and 43, respectively.

### Token Refresh Process for Browser Extension

Referring now to FIGS. 5A to 5D, which in schematic diagrams 500A, 500B, 500C illustrate an example process for access authentication, in the context of browser extension application, based on a token refresh process, in accordance with some example embodiments. Diagrams 500A, 500B, 500C, when placed in a vertical order, form an example token access and refresh process 500, in accordance with some example embodiments. The process 500 starts at step 51, which differentiates from step numbers used in FIGS. 4A to 4C.

An OAuth “Authorization Code Grant” requires secure storage of a client secret. In such an OAuth implementation, a browser extension is considered a public client or agent, and not a confidential client, and storage of client secrets in an extension (public client or agent) is not recommended. The proposed architecture as described herein implements a PKCE-based exchange in addition to the Authorization Code Grant flow to allow the browser extension to obtain OAuth tokens, while delegating secret storage to a back-end application, such as a secure storage on user device 130.

The authentication flow begins with an application on a user device 130, which may be for example a mobile application on a mobile device 130b, generating and storing a PKCE code verifier at step 51, which may be a cryptographically random string. The code verifier is then stored to secure storage on the mobile device at step 52. From the generated code verifier, a PKCE code challenge is generated by the mobile application at step 53. For example, a code challenge may be a base64-encoded SHA-256 hash of the code verifier.

At step 54, a user sign-in request is made to the authentication service of the application services tier, e.g., system or platform 100. This sign-in request may include user credentials, the PKCE code challenge, as well as the challenge method used by the mobile application to generate it. The authentication service then verifies the provided user credentials at step 55, and caches the PKCE code challenge and challenge method locally at step 56.

In some embodiments, the authentication service of system 100 may optionally direct the mobile application to proceed to further steps 57 and 58 in an application flow, for execution by the mobile device user. These additional steps might include, for example, a two-factor authentication step, or a terms and conditions agreement step. For each further step in the application flow optionally executed in sequence, the mobile application may make an execute request to the authentication service with the response from that step in the authentication flow.

Once all authentication steps have been completed, the authentication service of system 100 at step 59 issues one or more OAuth tokens and passes those tokens in a request, that includes at least the user ID, code challenge and challenge method, to the resource owner (RO) proxy of the application services tier at step 59. The resource owner proxy is responsible for issuing client access tokens back to the mobile application running on the mobile device.

Continuing onto diagram 500B at FIG. 5B, steps 60 to 62 occur when no access token is currently cached by the resource owner proxy, then the service makes a request to the authorization server of system 100 at step 60 for an access token for use by the RO proxy, using its client ID and secret. The authorization server, after verifying the passed credentials, and assuming the passed credentials are correct, responds with a resource owner proxy access token at step 61, which the resource owner proxy caches locally for future requests at step 62, including possibly requests by other users accessing the service.

When the resource owner proxy has a valid access token, either from its local cache, or via the request process, it sends a request to token services module 180 of system 100 at step 63 to request one or more user access tokens. The request may include the code challenge, the challenge method, and the user ID, and may further include the resource owner proxy's access token as a bearer token for authentication and authorization.

The token services module 180 issues an access token at step 64 for the user ID, which include the user ID of the mobile application user as the subject grant. A refresh ID is also issued at step 65; this is an opaque identifier used as a key to identify the refresh token. The access and refresh tokens are routed at step 66, along with their ID numbers, and the challenge and method used to create them, to the token persistence service of system 100 for storage.

The token services module 180 returns the access token and the refresh ID (the refresh token itself is not returned) to the resource owner proxy that requested the tokens on behalf of the user at step 67. In turn, the resource owner proxy at step 68 returns these tokens to the authentication service, which then in turn returns them to the mobile application at step 69, now referring to FIG. 5C. The mobile application stores the tokens to the secure storage running on the mobile device at step 70. The browser extension running on the mobile device 130b is able to retrieve the access token from secure storage, as required, in order to make requests from various services, which it will typically access through an API gateway that forms part of the application services tier.

Upon expiry of the access token at the end of its term, a refresh process or flow, including steps 72 to 84, can be initiated by the browser extension running on the mobile device to obtain a new access token in some embodiments. This flow begins with the browser extension at step 72 retrieving the code verifier and refresh ID from secure storage on the mobile device. The browser extension then at step 73 makes a token refresh request to the API gateway of system 100, and the token refresh request may include the code verifier and refresh ID. The API gateway then forwards this request at step 74 to the resource owner proxy.

The resource owner proxy then makes a token refresh request to the API gateway using its own access token as the bearer token at step 75, the token refresh request includes the code verifier, refresh ID. As with the login flow, the resource owner proxy may need to request an access token if it does not have one cached locally. The API gateway at step 76 validates the bearer token attached by the resource owner proxy, including its scope, and makes a request, including the code verifier and refresh ID, to the token service module 180 of system 100 at step 77.

Continuing onto FIG. 5D, the token services module 180 validates the request, and issues new access and refresh tokens. At step 78, the token services module 180 retrieves the stored OAuth tokens, challenge method and code challenge for the user from the token persistence service of the application services tier, using the refresh ID included in the request from step 77. The token services module 180 then validates the refresh token at step 79, including checking that the refresh token is not expired, validates the bearer token (the resource owner proxy access token passed with the request), applies the code challenge method to the code verifier, and verifies that result by comparing it to the stored code challenge for the session. Once these and any other relevant verification steps have been completed, the token service issues new access and refresh tokens, and a new refresh ID at step 80. These are then stored, as previously, to the token persistence service at step 81, before being returned to the API gateway at step 82, which returns them to the resource owner proxy at step 83, which in turn passes them back to the browser extension running on the mobile device at step 84. The browser extension stores the updated tokens including the new access token to the secure storage on the mobile device to complete the process at step 85.

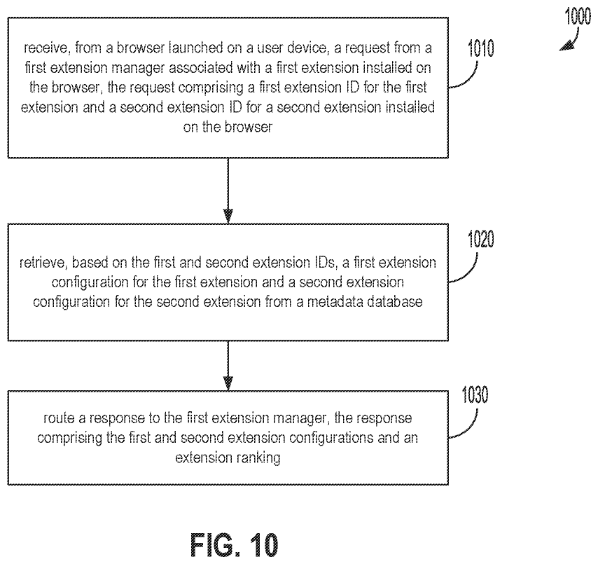

FIG. 10 shows an example process 1000 implemented by system 100 in FIG. 1, in accordance with some example embodiments.

At step 1010, system 100, such as extension orchestrator 150, receives, from a browser 700 launched on a user device 130, a request from a first extension manager (e.g., Extension Manager B 112b) associated with a first extension 760b installed on the browser 700, the request comprising a first extension ID for the first extension and a second extension ID for a second extension (e.g., Extension A 760a) installed on the browser 700.

At step 1020, extension orchestrator 150 retrieves, based on the first and second extension IDs, a first extension configuration for the first extension 760b and a second extension configuration 760a for the second extension from a metadata database 850.

At step 1030, extension orchestrator 150 routes a response to the first extension manager 112b, the response comprising the first and second extension configurations and an extension ranking.

In some embodiments, the extension ranking is obtained from the metadata database 850.

In some embodiments, the extension ranking comprises the first or second extension ID.

In some embodiments, the extension ranking is determined based on a set of priority rules stored in the metadata database 850.

In some embodiments, the response further comprises a list of domains that support the first extension or the second extension.

In some embodiments, based on the extension ranking in the response, the first extension manager is configured to be a master extension manager in control of the second extension.

In some embodiments, the first extension manager, acting as the master extension manager, transmits one or more control commands from the system to a second extension manager on the second extension manager.

In some embodiments, the transmission is encapsulated in one or more inter-extension messages 820.

In some embodiments, the set of priority rules comprises a set of logics for selecting a priority extension from a plurality of extensions for a specific feature.

In some embodiments, the set of logics includes selection logics based on a user account associated with one or more of the plurality of extensions.

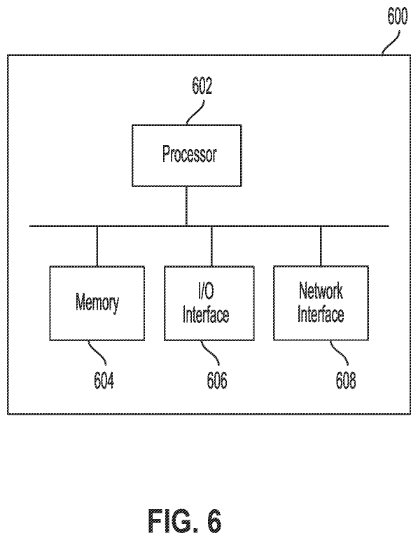

FIG. 6 is a schematic diagram of another example computing device 600 that implements a system (e.g., one or more components of system 100 or user device 130), in accordance with an embodiment. As depicted, computing device 600 includes one or more processors 602, memory 604, one or more I/O interfaces 606, and, optionally, one or more network interfaces 608.

When computing device 600 is a user device 130, for example, the extension framework, including one or more extension managers and an inter-extension messaging protocol, operate to transform the user device 130 into a special purpose machine that is capable of orchestrating multiple extensions enabled on a browser 300, 700 on the device 130 to deliver a seamless user experience. For instance, the look and feel of a website or web page rendered by the browser 300, 700 are based in part on content script injected by the one or more extensions, which are managed by the extension managers and the extension orchestration process described herein.

Each processor 602 may be, for example, a microprocessor or a microcontroller, a digital signal processing (DSP) processor, an integrated circuit, a field programmable gate array (FPGA), a reconfigurable processor, a programmable read-only memory (PROM).

Memory 604 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 604 may store code executable at processor 602, which causes components of system to function in manners disclosed herein. Memory 604 includes a data storage. In some embodiments, the data storage includes a secure datastore. In some embodiments, the data storage stores received data sets, such as textual data, image data, or other types of data.

Each I/O interface 606 enables computing device 600 to interconnect with one or more input devices, such as a keyboard, mouse, camera, touch screen and a microphone, or with one or more output devices such as a display screen and a speaker.

Each network interface 608 enables computing device 600 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The methods disclosed herein may be implemented using a system that includes multiple computing devices 600. The computing devices 600 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 600 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects.

Although the embodiments have been described in detail, it should be understood that various changes, substitutions and alterations can be made herein without departing from the scope as defined by the described embodiments.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

1. A computer-implemented system for orchestrating at least two browser extensions installed on a browser, the system comprising:
a communication interface;
at least one processor;
non-transitory computer readable memory in communication with said at least one processor;
software code stored in said non-transitory computer readable memory, which when executed at said at least one processor causes said system to:
receive, from a browser launched on a user device, a request from a first extension manager associated with a first extension installed on the browser, the request comprising a first extension ID for the first extension and a second extension ID for a second extension installed on the browser;
retrieve, based on the first and second extension IDs, a first extension configuration for the first extension and a second extension configuration for the second extension from a metadata database; and
route a response to the first extension manager, the response comprising the first and second extension configurations and an extension ranking.

2. The system of claim 1, wherein the extension ranking is obtained from the metadata database.

3. The system of claim 2, wherein the extension ranking comprises the first or second extension ID.

4. The system of claim 3, wherein the extension ranking is determined based on a set of priority rules stored in the metadata database.

5. The system of claim 1, wherein the response further comprises a list of domains that support the first extension or the second extension.

6. The system of claim 1, wherein based on the extension ranking in the response, the first extension manager is configured to be a master extension manager in control of the second extension.

7. The system of claim 6, wherein the first extension manager, acting as the master extension manager, transmits one or more control commands from the system to a second extension manager on the second extension manager.

8. The system of claim 7, wherein the transmission is encapsulated in one or more inter-extension messages.

9. The system of claim 4, wherein the set of priority rules comprises a set of logics for selecting a priority extension from a plurality of extensions for a specific feature.

10. The system of claim 9, wherein the set of logics includes selection logics based on a user account associated with one or more of the plurality of extensions.

11. A computer-implemented method for orchestrating at least two extensions installed on a browser, the method comprising:
receive, by an extension orchestrator, from a browser launched on a user device, a request from a first extension manager associated with a first extension installed on the browser, the request comprising a first extension ID for the first extension and a second extension ID for a second extension installed on the browser;
retrieve, based on the first and second extension IDs, a first extension configuration for the first extension and a second extension configuration for the second extension from a metadata database; and
route a response to the first extension manager, the response comprising the first and second extension configurations and an extension ranking.

12. The method of claim 11, wherein the extension ranking is obtained from the metadata database.

13. The method of claim 12, wherein the extension ranking comprises the first or second extension ID.

14. The method of claim 13, wherein the extension ranking is determined based on a set of priority rules stored in the metadata database.

15. The method of claim 11, wherein based on the extension ranking in the response, the first extension manager is configured to be a master extension manager in control of the second extension.

16. The method of claim 15, wherein the first extension manager, acting as the master extension manager, transmits one or more control commands from the system to a second extension manager on the second extension manager.

17. The method of claim 16, wherein the transmission is encapsulated in one or more inter-extension messages.

18. The method of claim 14, wherein the set of priority rules comprises rules for selecting a priority extension from a plurality of extensions for a specific feature.

19. The method of claim 18, wherein the set of priority rules comprises user-specific priority rankings based on a user account associated with one or more of the plurality of extensions.

20. A computer-implemented method for authenticating a user, the method comprising:
receiving a user request from a user device for an access token, the user request comprising a user identifier (ID) and a code challenge;
validating the code challenge;
upon validating the code challenge, generating a user access token and a refresh token for the user ID;
transmitting the user access token and a refresh ID based on the refresh token back to the user device;
receiving a token refresh request comprising a code verifier and the refresh ID from the user device;
validating the token refresh request;
upon validating the token refresh request, generating an updated access token and an updated refresh; and
transmitting the updated access token and an updated refresh ID based on the updated refresh token back to the user device.
